(19) United States
(12) Patent Application Publication
(10) Pub. No.: US 2012/0177856 A1
(43) Pub. Date: Jul. 12, 2012

(54) PVC RESIN COMPOSITIONS

(75) Inventors: Ludovic Hardouin-Duparc, Reims (FR); Jean Francois Marcotte, Maisons-Alfort (FR); Jean Luc Schnitzler, Breval (FR); Frederic Lyoen, Pont-Audemer (FR); Sophie Lacroix, Loyettes (FR)

(73) Assignee: ARKEMA FRANCE, Colombes (FR)

(21) Appl. No.: 13/387,533

(22) PCT Filed: Jul. 27, 2010
(86) PCT No.: PCT/EP10/60879

§ 371 Date: Mar. 30, 2012

(30) Foreign Application Priority Data
Jul. 28, 2009 (FR) 0955272

(51) Int. Cl. B32B 1/08; C08K 5/098; C08K 5/52; C08K 3/34; C08K 3/26; C08K 3/24; C08K 5/07; C08K 5/053; C08K 5/13; C08K 5/101; C08K 5/17; C08L 51/00; C08K 5/1515

(52) U.S. Cl. 428/36.6; 525/76; 524/394; 524/140; 524/444; 524/424; 524/114; 524/357; 524/388; 524/323; 524/316; 524/186; 524/438

(57) ABSTRACT

The invention concerns the use of a composition comprising:
45% to 85% by weight, with respect to the total weight of the polymers present in the composition, of one or more non-grafted PVC resins with a K value in the range 50 to 90; and
15% to 55% by weight, with respect to the total weight of the polymers present in the composition, of one or more resins of PVC grafted onto one or more polymers selected from C1-C18 alkyl polyacrylates, C1-C18 alkyl polymethacrylates and mixtures thereof;
   for the manufacture of tubes for transporting drinking water or physiological liquids.

The present invention relates to a composition comprising a mixture of particular polyvinyl chloride resins, to its preparation process, to a tube comprising said composition and to the uses of said composition.

Polyethylene (hereinafter PE) tubes are in extremely widespread use in the field of drinking water distribution. Piping produced from polypropylene or rigid polyvinyl chloride also exists; such materials have the advantage of being inert both chemically and physically when used to transport drinking water. Such piping is easy to manufacture and inexpensive; thus, it is in widespread use in supply installations.

In general, chlorinated derivatives are added to the water in order to prevent the proliferation of bacteria and fungi in the piping. The permanent presence in such piping of said chlorinated derivatives, which have anti-bacterial and antifungal properties, gives rise to cracks or zones of stress cracking after prolonged use of such piping.

As a consequence, polymer compositions for the manufacture of pipes or tubes destined for the transport of fluid that can, for example, be installed in fixed or mobile drinking water supply installations are being investigated.

Thus, the material under investigation must satisfy very precise specifications. It must behave correctly under pressure. In particular, the maximum nominal pressure required for irrigation is 16 bar, and 10 bar for the transport of drinking water. As indicated above, the material must satisfy health authority regulations regarding contact with foodstuffs. For this reason, the material has to tolerate the continuous presence of chlorinated compounds necessary for disinfection, as mentioned above.

Further, it must be shock-resistant, and it must have good crush strength, but at the same time it must be sufficiently flexible to be capable of being rolled up and unrolled easily.

Ideally, the material should be capable of being adapted to existing mechanical connections, in particular those in current use for PE pipes.

Finally, it must have good dimensional stability at ambient temperature, i.e. it must have a high Vicat point.

Thus, a material is being sought that has physical characteristics similar to PE that is already in use, in terms of strength and flexibility, while being ideally suited to tolerating the continuous presence of chlorinated derivatives.

Polyvinyl chloride (hereinafter PVC) has the advantage of being ideally suited to tolerating the continuous presence of chlorinated compounds because of its chemical constitution. However, PVC has the disadvantage of being far too rigid for the envisaged use. In particular, it has the disadvantage of being impossible to roll up and unroll.

PVC compositions comprising plasticizers in order to render the material more flexible have been envisaged. However, the presence of plasticizers in PVC has a tendency to reduce the Vicat point, leading to an unacceptable dimensional stability of the material for the envisaged use.

A particular polyvinyl chloride (PVC) resin composition has been discovered that can overcome the problems posed.

The invention concerns a composition comprising:
45% to 85% by weight, with respect to the total weight of the polymers present in the composition, of one or more non-grafted PVC resins with a K value in the range 50 to 90, preferably in the range 60 to 80; and
15% to 55% by weight, with respect to the total weight of the polymers present in the composition, of one or more resins of PVC grafted onto one or more polymers selected from C1-C18 alkyl polyacrylates, C1-C18 alkyl polymethacrylates and mixtures thereof.

Finally, the invention pertains to a process for preparing such a composition, to a tube formed from said composition and to uses.

Further characteristics, aspects, aims and advantages of the present invention will become apparent from the following description and examples.

The term “polymers present in the composition” as used in the present invention means the non-grafted PVC resin or resins and the grafted PVC resin or resins.

It should be pointed out that the expression “in the range” should be construed as including each of the limits mentioned.

### Non-Grafted Polyvinyl Chloride

The composition of the invention comprises 45% to 85% by weight, with respect to the total weight of the polymers present in the composition, of one or more non-grafted PVC resins with a K value in the range 50 to 90. Preferably, the value of the constant K value is in the range 60 to 80.

The K value is measured using a known method. The viscosity index, determined in accordance with ISO standard R 174, is measured at 25° C. at a concentration of 0.5 g of PVC in 100 mL of cyclohexanone. The viscosity index obtained corresponds to a K value given by DIN standard 53726.

In one embodiment, the non-grafted PVC resin of the invention is obtained by a suspension or micro-suspension process. PVC prepared using an emulsion or bulk method may also be used.

Preferably, the non-grafted PVC is linear and not crosslinked.

Preferably, the composition of the invention comprises 65% to 80% by weight, with respect to the total weight of the polymers present in the composition, of one or more non-grafted PVC resins with a K value in the range 50 to 90.

### Grafted Polyvinyl Chloride

The composition of the invention comprises 15% to 55% by weight, with respect to the total weight of the polymers present in the composition, of one or more resins of PVC grafted onto one or more polymers selected from C1-C18 alkyl polyacrylates, C1-C18 alkyl polymethacrylates and mixtures thereof, also designated as C1-C18 alkyl poly(meth)acrylate.

More particularly, the grafted PVC resin of the invention is a thermoplastic elastomer based on grafted vinyl chloride co-polymerisates containing 35% to 60% by weight, with respect to the total weight of grafted vinyl chloride co-polymerisate, of a grafted (co)polymer.

The term “elastomer” as used in the present invention means a polymer or copolymer with a glass transition temperature of 0° C. or less. Such a polymer or copolymer preferably has a Young's modulus, measured at the temperature of use, in the range 10 000 Pa to 100 000 000 Pa, preferably in the range 50 000 Pa to 10 000 000 Pa.

The grafted PVC resin of the invention may be prepared by (co)polymerization of:
80% to 100% by weight of vinyl chloride; as well as
0 to 20% by weight of ethylenically unsaturated supplemental copolymerizable co-monomers during a polymerization at 0° C. to 45° C.; and
40% to 65% by weight, with respect to the total weight of grafted vinyl chloride copolymerisate, of a crosslinked grafted base containing a copolymerisate matrix comprising motifs selected from acrylic acid esters, methacrylic acid esters and mixtures thereof, and optionally containing 0.01% to 5% by weight of ethylenically supplemental co-monomer units copolymerizable with acrylic acid and/or methacrylic acid esters.

Preferably, the acrylic and methacrylic acid esters are esters of alcohols containing 1 to 18 carbon atoms. Methyl, ethyl, propyl, n-butyl, hexyl, heptyl, octyl, 2-ethylhexyl, nonyl, isononyl, decyl, isodecyl, undecyl, dodecyl and tridecyl acrylates and methacrylates are preferred.

Preferably, C2-C16 alkyl acrylates and C6-C13 alkyl methacrylates are preferred.

More particularly, n-butyl acrylate, 2-ethylhexyl acrylate and mixtures thereof are preferred.

Preferably, the elastomer comprises 45% to 60% by weight, with respect to the total weight of grafted copolymerisate, of a crosslinked grafted base composed of a crosslinked copolymerisate of n-butyl acrylate, 2-ethylhexyl acrylate and mixtures thereof, or of a crosslinked copolymerisate of acrylic acid ester/ethylene/vinyl acetate with an acrylate content in the range 35% to 70% by weight or mixtures of said copolymerisates, the copolymerisates being crosslinked with 0.05% to 0.5% by weight of one or more multiply ethylenically unsaturated copolymerizable co-monomers originating from the group formed by diallyl phthalate, allyl methacrylate, ethylene glycol dimethacrylate, butylene glycol diacrylate, trimethylene glycol diacrylate and trimethylolpropane triacrylate.

More particularly, the composition comprises a quantity of crosslinked grafted base containing a copolymerisate matrix comprising units selected from acrylic acid esters, methacrylic acid esters and mixtures thereof, in the range 15% to 98% by weight with respect to the total weight of the polymers present in the composition, preferably in the range 40% to 60%.

Preferably, VK710 resin supplied by Vinnolit is used.

In another embodiment of the invention, the grafted PVC resin of the invention may be prepared by copolymerizing vinyl chloride and poly(methyl methacrylate-block-butyl acrylate-block-methyl methacrylate) (MAM), flexible acrylic polymers or copolymers, for example resins based on acrylic esters such as polybutyl acrylate and its copolymers with other acrylic or vinyl monomers, as well as mixtures thereof.

In particular, the elastomers may be selected from acrylic derivatives supplied by ARKEMA under the trade marks Durastrength® 200, 320, 340 and 360, acrylic derivatives supplied by Rohm & Haas under the trade marks Paraloid® KM342, KM342B, KM361, KM370 and KM1, and acrylic derivatives supplied by KANEKA under the trade marks FM22® and FM50®.

Preferably, the composition of the invention comprises 20% to 45% by weight, with respect to the total weight of the polymers present in the composition, of one or more grafted PVC resins as defined above.

Preferably, the composition of the invention comprises 10% to 20% by weight, with respect to the total weight of the polymers present in the composition, of C1-C18 alkyl poly(meth)acrylate present in the grafted PVC resin.

More particularly, the composition of the invention comprises 12% to 18% by weight, with respect to the total weight of the polymers present in the composition, of C1-C18 alkyl poly(meth)acrylate present in the grafted PVC resin.

In accordance with another embodiment, the composition of the invention may comprise a compatibilizing polymer selected from copolymers or terpolymers of vinyl chloride and vinyl acetate (VC/VA), copolymers or terpolymers of vinyl chloride and acrylic derivatives (VC/DA), thermoplastic polyurethanes (TPU), thermoplastic polyether esters, elastomeric acrylonitrile/butadiene copolymers (NBR), ethylene/vinylic monomer copolymers (EVA), ethylene/vinylic monomer/carbonyl terpolymers, melt-processible acrylic elastomers, copolymers with polyamide blocks and polyether blocks (or polyether block amides), chlorinated or chlorosulfonated polyethylenes, ethylene/alkyl (meth)acrylate or (meth)acrylic acid polymers that may or may not be functionalized, MBS type core-shell polymers, SBM block terpolymers, PVDF and powdered polyamide resins.

An example of a VC/VA copolymer is the product Lacovyl GA from Arkema; an example of a VC/DA copolymer is the product Vinnolit VK from Vinnolit; an example of TPU is the product Estane from Goodrich; an example of a thermoplastic polyether ester is the product Hytrel from DuPont; an example of an acrylonitrile/butadiene copolymer (NBR) is the product Chemigum from Eliokem;

an example of a polyether block amide is the product Pebax from Arkema; an example of EVA is the product Evatane from Arkema; an example of an ethylene/vinylic monomer/carbonyl terpolymer is the product Elvaloy from DuPont; examples of ethylene/alkyl (meth)acrylate or (meth)acrylic acid polymers, functionalized or otherwise, are the products Lotryl, Lotader and Orevac from Arkema; an example of chlorinated or chlorosulfonated polyethylenes is the product Tyrin from DuPont; an example of a melt-processible acrylic elastomer is the product Alcryn from Apa; and an example of powdered polyamide resins is the product Orgasol from Arkema.

The composition of the invention may also comprise, inter alia, an additive that may in particular be selected from pigments or fillers, stabilizers, antioxidants, processing aids, lubricants or flame retardants. Particular additives in routine use in compositions based on vinyl resin that may be cited include metallic salts of organic carboxylic acids, organic phosphoric acids, zeolites, hydrotalcites, epoxy compounds, beta-diketones, polyhydric alcohols, phosphorus-containing, sulfur-containing or phenolic antioxidants, ultraviolet absorbers, for example benzophenones, benzotriazoles, and oxanilide derivatives, cyanoacrylates, hindered amine light stabilizers (HALS), perchloric acid salts, and other inorganic metal-based compounds, lubricants, for example organic waxes, fatty alcohols, fatty acids, fatty esters, metallic salts, fillers, for example chalk or talc, and pigments such as carbon black or copper phthalocyanines.

Further, the composition may comprise 0.1% to 10% by weight, with respect to the total composition weight, of the additives mentioned hereinabove.

The composition of the invention may be used to constitute a structure. Said structure may be single-layered when it is formed solely by the composition of the invention.

This structure may also be a multi-layered structure when it comprises at least two layers and at least one of the various layers forming the structure is formed by the composition of the invention.

Preferably, the composition of the invention constitutes a single-layered structure.

The structure, whether it be single-layered or multi-layered, may in particular be in the form of fibers, a film, a tube, a hollow body, an injection molded part or a pellet.

The invention also concerns a process for preparing a composition as defined hereinabove. According to this process, the composition may be prepared using any method that can be used to produce a homogeneous mixture containing the composition of the invention, and other optional additives, such as by melt extrusion, compacting or mixing, for example using a roller-type mixer (open mill) or a kneader.

More particularly, the composition of the invention is prepared by mixing all of its components in the molten state, especially in a process known as a direct process.

Advantageously, the composition may be obtained in the form of granules by compounding on a tool that is known to the skilled person, such as: a single-screw or twin-screw extruder, a co-mixer, or an internal mixer.

The composition of the invention obtained by the preparation process described hereinabove may then be transformed for use or for a subsequent transformation that is familiar to the skilled person, using tools such as: an injection-molding press, an extruder, etc.

The process for preparing the composition of the invention may also use a single-screw or twin-screw extruder supplying an injection-molding press or an extruder without any intermediate granulation using processing equipment that is familiar to the skilled person.

The invention also pertains to an article obtained by injection molding, extrusion, co-extrusion, hot compression, or multi-injection using at least one composition as defined hereinabove.

The invention also pertains to a tube comprising the composition of the invention.

In a particular embodiment, the tube is manufactured by means of a continuous biaxial drawing manufacturing process; said process is described in French patent application FR 2 806 956.

The composition of the invention may advantageously be used for the production of tubes or pipes for applications in the field of drinking water distribution, such as in piping, or hosepipes, in the medical or para-medical field, such as tubes used for the transport of physiological liquids.

The present invention will now be described in the examples given below, of course, solely by way of non-limiting illustration.

### EXAMPLES

### 1/ Preparation of Compositions

The following products were used to prepare the compositions below:

Polyvinyl chloride:

PVC resin: polyvinyl chloride with a K value of 70 supplied by Arkema under the trade mark Lacovyl S7015.

Grafted polyvinyl chloride:
Grafted PVC resin: polyvinyl chloride 50% grafted onto a polyacrylate, supplied by Vinnolit under the trade mark VK710.

Plasticizers:
DOP plasticizer: supplied by Arkema under the trade mark Garbeflex.

Stabilizers:
Soybean oil: supplied by Akcros under the trade mark Lankroflex.
Ba/Zn: mixture of barium and zinc supplied by Lagor under the trade mark Lastab.
Ca/Zn: mixture of calcium and zinc supplied by Reagens under the trade mark Stabiol.
Ca stearate: calcium stearate supplied by Greven under the trade mark Ligastab CAPSE.
Zn stearate: zinc stearate supplied by Greven under the trade mark Ligastab ZNE.

Additives:
Processing aid: processing aid constituted by polymethyl methacrylate (PMMA) supplied by Arkema under the trade mark Plastistrength.
External lubricant: polyethylene wax supplied by Honeywell under the trade mark AC wax.
Internal lubricant: polyethylene wax supplied by Oleon under the trade mark Radia.
Antioxidant: phosphite supplied by Baerlocher under the trade mark Barostab.
Pigment: ultramarine violet supplied by Holliday under the trade mark Prestige.

The proportions used are shown in the following table:

Compositions

| | A | B | 1 |
|---|---|---|---|
| | comparative | comparative | invention |
| PVC resin | 100 | 34 | 70 |
| Grafted PVC resin | — | 66 | 30 |
| DOP plasticizer | 28 | — | — |
| Soya oil stabilizer | 4 | 7.5 | 7.5 |
| Ba/Zn stabilizer | 2 | 4 | — |
| Ca/Zn stabilizer | — | — | 4 |
| Ca stearate | — | 0.4 | 0.4 |
| stabilizer | | | |
| Zn stearate | — | — | 0.2 |
| stabilizer | | | |
| Processing aid | — | 1 | 1 |
| Internal lubricant | — | — | 0.5 |
| External lubricant | 0.2 | — | 0.6 |
| Antioxidant | 0.6 | — | 0.6 |
| Pigment | 0.02 | — | 0.6 |

Compositions A and B were comparative compositions. Composition 1 was a composition in accordance with the invention.

The compositions for this study were prepared by mixing (compounding) using a Samafor single-screw extruder, diameter 60 mm, L/D=28. The ingredients were introduced via the supply hopper into the first barrel.

### 2/ Extrusion of Compositions

The various compositions were extruded at an extrusion temperature in the range 160° C. to 180° C.

### 3/ Characterization of Materials

3.1 Measurement of Vicat point (° C.): the Vicat point was determined in accordance with ISO standard 306.
3.2 Measurement of hardness (Shore D): the hardness was determined in accordance with ISO standard 868.
3.3 Annular rigidity of tube (kN/m²): the annular rigidity was determined in accordance with ISO standard 9969.
3.4 Measurement of maximum strength (MPa): the maximum strength was determined in accordance with ISO standard 527.

Tubes with the above compositions were compared with a PE tube. The results are recorded in the table below:

Compositions

| | A | B | 1 | PE |
|---|---|---|---|---|
| | comp | comp | inv | comp |
| Vicat point | 42 | 48 | 62 | 70 |
| 5 kg (° C.) | | | | |
| Hardness | 44 | 51 | 64 | 57 |
| (Shore D) | | | | |
| Rigidity | 11 | 52 | 183 | 52 |
| (Shore D) | | | | |
| R max | 21 | 20 | 30 | 13 |
| (Shore D) | | | | |

3.5 Measurement of percentage elongation at break in a chlorinated medium (MPa):

For this study, three tubes were compared:
the first tube was formed from high density polyethylene (PE, NF PE 80 pipelife 32×3.0 PN 12.5 tube);
the second tube was formed from polyvinyl chloride (PVC, NF PVC Alphacan Lucoflex 32×2.4 PN 16 tube); and
the last tube, denoted 2 (inv), was a single layered tube in accordance with the invention comprising a mixture of PVC (homopolymer, 70% in the mixture, PVC type S110P) and butyl acrylate grafted PVC (30%, VK 710). Thus, the quantity of acrylic monomer in this composition was 15%.

These tubes were placed in water disinfected with chlorine dioxide (ClO₂) in an amount of 100 ppm, for 3 months at 40° C. This concentration was much higher than that contained in standard drinking water piping. The quantity of ClO₂ for standard treatments is 2 ppm at ambient ground temperature.

The elongation at break was measured before immersion (t=0) and after 3 months immersion (t=3 months).

Oxidation of polymers generally results in chain cleavage. Chain cleavage causes a reduction in the elongation at break under tension. The tensile tests were carried out in accordance with ISO standard 527, using 1BA test specimens. The draw speed was 15 mm/min.

The table below shows the results obtained for the percentage elongation at break:

| | PE | PVC | 2 |
|---|---|---|---|
| Elongation (%) | comparative | comparative | invention |
| At t = 0 | 500 | 125 | 130 |
| At t = 3 | 100 | 140 | 140 |
| months | | | |

The elongation at break of the tube formed from PE collapsed after 3 months immersion in chlorinated water.

### 4/ Conclusion

The composition of the invention has the advantage of being compatible with the continuous presence of chlorinated compounds, of being pressure-resistant (R max), at the same time being sufficiently flexible to be unrolled.

1. A composition comprising:
45% to 85% by weight, with respect to the total weight of the polymers present in the composition, of one or more non-grafted PVC resins with a K value in the range 50 to 90; and
15% to 55% by weight, with respect to the total weight of the polymers present in the composition, of one or more resins of PVC grafted onto one or more polymers selected from C1-C18 alkyl polyacrylates, C1-C18 alkyl polymethacrylates and mixtures thereof.

2. The composition of claim 1, wherein the non-grafted PVC resin present in the composition is linear and not crosslinked.

3. The composition of claim 1, wherein the non-grafted PVC resin present in the composition has a K value in the range 60 to 80.

4. The composition of claim 1, wherein the composition comprises 10% to 20% by weight, with respect to the total weight of the polymers present in the composition, of C1-C18 alkyl poly(meth)acrylate present in the grafted PVC resin.

5. The composition of claim 1, wherein the grafted PVC resin comprises, as acrylate monomers: n-butyl acrylate, 2-ethylhexyl acrylate and mixtures thereof.

6. The composition of claim 1, wherein comprising at least one additive that is metallic salts of organic carboxylic acids, organic phosphoric acids, zeolites, hydrotalcites, epoxy compounds, beta-diketones, polyhydric alcohols, phosphorus-containing, sulfur-containing or phenolic antioxidants, ultraviolet absorbers, cyanoacrylates, hindered amine light stabilizers (HALS), perchloric acid salts, and other inorganic metal-based compounds, lubricants, metallic salts, fillers, or pigments.

7. The composition of claim 1, in the form of a single layered structure.

8. The composition of claim 1, in the form of fibers, a film, a sheet, a tube, a hollow body or an injection-molded part.
